(19) United States
(12) Patent Application Publication
(10) Pub. No.: US 2009/0044873 A1
(43) Pub. Date: Feb. 19, 2009

(54) Faucet Control System

(75) Inventor: Kevin Walter, Franklin, WI (US)

Correspondence Address: JANSSON SHUPE & MUNGER LTD., 245 MAIN STREET, RACINE, WI, 53403, US

(73) Assignee: Tracy Walter, Franklin, WI (US)

(21) Appl. No.: 12/173,193

(22) Filed: Jul. 15, 2008

Related U.S. Application Data
(60) Provisional application No. 60/954,090, filed on Aug. 6, 2007.

(51) Int. Cl. F16K 11/00

(52) U.S. Cl. 137/606

(57) ABSTRACT

An improved faucet control system for reducing water and energy usage in manual washing operations. The faucet control system has a foot pedal that controls the flow of water without the need of operating the faucet. The foot pedal, upon alternate activations, reverses the polarity of an electrical output pulse to the at least one latching solenoid valve, whereby flow through the faucet is controlled in an on/off fashion. At least one battery is present as a power supply and the system consists of at least one latching solenoid valve in at least one faucet supply line.

### RELATED APPLICATION

This application claims the benefit of U.S. Provisional Application No. 60/954,090 filed on Aug. 6, 2007, the contents of which is incorporated by reference herein in its entirety.

### FIELD OF THE INVENTION

This invention is related generally to water flow and more particularly to regulating water flow from a faucet using at least one magnetic solenoid valve, a battery and a foot pedal.

### BACKGROUND OF THE INVENTION

Faucet control systems are used to regulate the flow of water from a faucet while allowing the operator to use the faucet hands-free. Such faucet control systems in the prior art typically consist of a proximity sensor which senses the presence of a person and then automatically turns the water on or off. Other faucet control systems in the prior art have a switch requiring the user to apply pressure in order to keep the water flow in the on position. Examples of these prior art faucet control systems are disclosed in the following United States patents: U.S. Pat. No. 6,753,554 (Gomes, et al.), U.S. Pat. No. 6,305,663 (Miller), U.S. Pat. No. 5,595,216 (Pilolla), U.S. Pat. No. 5,318,070 (Surabian), U.S. Pat. No. 4,5630,780 (Pollack), U.S. Pat. No. 4,189,792 (Veach) and U.S. Pat. No. 3,505,692 (Forbes).

The faucet control systems of the prior art have, however, a number of problems and shortcomings. They often require that constant pressure be applied to the activation switch in order for the water flow to turn on, thereby making them difficult to operate. It would be desirable to have a faucet control system which has an activation switch where constant pressure does not have to be applied in order to allow water to flow from the faucet. The activation switch could be depressed once to allow the water to flow and depressed again by the user when it is desirable that the water flow stop. Having a system such as this would make the operation of the faucet control system user friendly and not awkward.

In addition, most faucet control systems of the prior art require that the system be hard wired to the house or building in which it is installed or that an outlet be present adjacent to the faucet. This can make installation costly and difficult. It would be desirable to have a water control system that is operated by a battery or battery pack. This would make installation simple and would allow any conventional faucet to be easily converted.

Additionally, most faucet control systems of the prior art utilize a lot of energy while they are in use. It would be desirable to have a faucet control system that utilizes magnetic solenoid valves which would only use a small amount of energy to turn the system on and off. A system such as this would not require energy to be constantly used while the water is in the on position. Energy conservation is becoming an ever important goal in today's modern world. By reducing energy a consumer is able to reduce environmental and social costs. Energy conservation can mitigate adverse impacts on the environment associated with energy consumption. By having a system such as this, energy consumption would be reduced since energy would not be used during the duration of the water flow, thereby extending the life of the battery or battery pack. Reduced energy consumption can also extend the working life of equipment and can have the effect of reducing necessary maintenance costs.

This invention meets these needs and overcomes other problems and shortcomings in the prior art with a water control system that is simple to operate, inexpensive to install and also energy efficient.

### OBJECTS OF THE INVENTION

It is an object of this invention to provide a faucet control system that includes an activation pedal which does not require constant pressure to allow the flow of water to continue, thereby making the system user friendly and not awkward.

Another object is to provide a faucet control system that is easy to install and would allow any conventional faucet to be converted into a faucet control system.

Another object is to provide a faucet control system which is energy efficient by not requiring that energy be used while the water is on.

These and other objects of the invention will be apparent from the following descriptions and from the drawings.

### SUMMARY OF THE INVENTION

In certain preferred embodiments, the at least one solenoid valve is a cold water solenoid valve and a hot water solenoid valve. Most preferred is where the battery and solenoid valve are mounted under a sink basin.

This invention is for a faucet control system of the type having a faucet with an on-off/rate-of-flow manual control valve, at least one faucet supply line, and an additional on-off valve that is solenoid-controlled in the supply line. The invention improvement comprises at least one battery, as a power supply; a latching solenoid valve in at least one faucet supply line; and a foot pedal, which, upon alternate activations, reverses the polarity of an electrical output pulse to the solenoid valve, whereby flow through the faucet is controlled in an on/off fashion by pedal activation.

It is highly preferred that the battery and latching solenoid valve are under a sink basin. In certain preferred embodiments, the at least one latching solenoid valve includes a cold-water solenoid valve and a hot-water solenoid valve, such valves being electrically connected for contemporaneous operation by the foot pedal.

Preferably, there is a hot-water shut-off valve and a cold-water shut off valve and wherein the hot-water latching solenoid valve and cold-water latching solenoid valve are downstream of the hot-water shut-off valve and a cold-water shut off valve respectively. Most preferred is where the hot-water latching solenoid valve and cold-water latching solenoid valve are physically separate modules separately installed in a hot water supply line and a cold water supply line.

### BRIEF DESCRIPTION OF THE DRAWINGS

The drawings illustrate a preferred embodiment including the above-noted characteristics and features of the invention. The invention will be readily understood from the descriptions and drawings. In the drawings:

FIG. 1 is a front perspective view of the invention mounted under a sink basin.

FIG. 2 is side perspective view of the invention mounted under a sink basin.

### DETAILED DESCRIPTION OF PREFERRED EMBODIMENTS

Magnetically latching solenoid valves employ magnets and electrical current to effect operations at expense of very little electrical power. When electrical current is applied to a coil by pushing the pedal, based on polarity of magnet and direction of current flow, the solenoid valve is latched or delatched. The positive portion of the battery energizes the positive part of the solenoid valve. When current polarity is reversed, by pushing the pedal a second time, the valve latches if in delatched position and vice versa. When the pedal is pushed the second time the positive end from the battery energizes the negative pole of the solenoid valve and forces the valve closed.

The latching solenoid valve is opened or closed by using pedal pressure to activate a small electric magnetic field which pulls a small piston up against a spring, thus revealing a “pilot hole” in the diaphragm which causes it to lift under pressure from the media and allow passage of water through the solenoid valve.

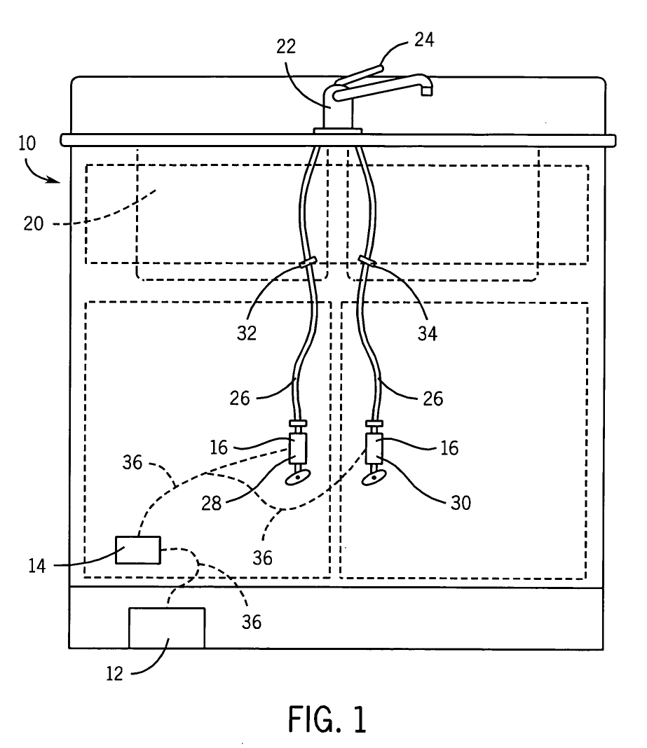

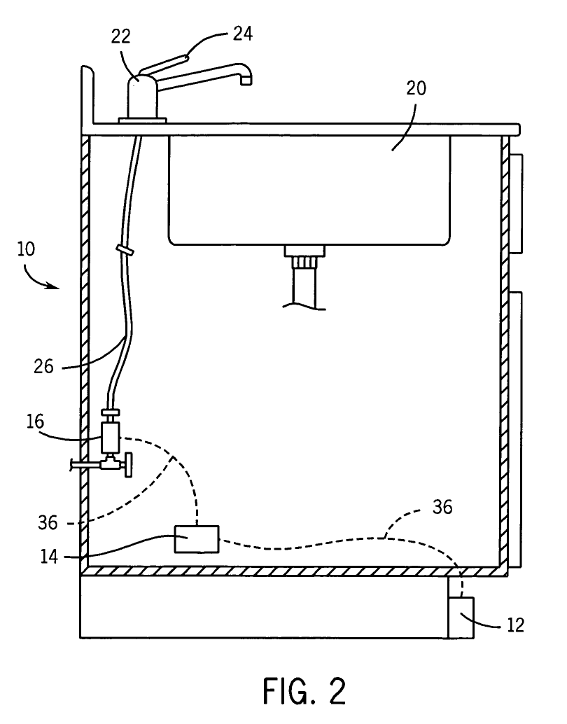

FIG. 1 illustrates an improved faucet control system 10 in accordance with this invention. As shown in FIGS. 1 and 2, improved faucet control system 10 is comprised of foot pedal 12, battery pack 14 and at least one latching solenoid valve 16. In highly preferred embodiments improved faucet control system 10 is mounted under sink basin 20.

As illustrated in FIGS. 1 and 2, faucet 22 has on-off/rate-of-flow manual control valve 24, at least one faucet supply line 26 and an additional on-off valve that is solenoid-controlled in the supply line 26. Improved faucet control system 10 has battery pack 14 which is a power supply. Foot pedal 12 is connected to battery pack 14 through the use of at least one conventional electrical wire 36. Battery pack 14 is connected to at least one latching solenoid valve 16 through the use of at least one conventional electric wire 36.

Foot pedal 12, upon alternate activations, reverses the polarity of an electrical output pulse to latching solenoid valve 16, whereby the flow through faucet 22 is controlled in an on/off fashion by pedal activation. As shown in FIGS. 1 and 2, latching solenoid valve 16 includes cold-water solenoid valve 28 and hot-water solenoid valve 30. Cold-water solenoid valve 28 and hot-water solenoid valve 30 are electrically connected for contemporaneous operation by foot pedal 12.

As illustrated in FIGS. 1 and 2, there is a cold-water shut-off valve 32 and hot-water shut off valve 34 in the respective faucet supply line 26. Cold-water latching solenoid valve 28 and hot-water latching solenoid valve 30 are downstream of cold-water shut-off valve 32 and hot-water shut off valve 34 respectively as shown in FIGS. 1 and 2 and are physically separate modules separately installed in a cold water supply line and a hot water supply line. Improved faucet control system 10 allows the water temperature and water flow to be preset to a users specification.

A wide variety of materials are available for the various parts discussed and illustrated herein. Although the invention have been shown and described in conjunction with specific embodiments thereof, it is to be understood that many alternatives, modifications and variations will be apparent to those skilled in the art. Accordingly, it is intended to embrace all such alternatives, modifications and variations that fall within the spirit and broad scope of the appended claims.

1. In a faucet control system of the type having a faucet with an on-off/rate-of-flow manual control valve, at least one faucet supply line, and an additional on-off valve that is solenoid-controlled in the supply line, the improvement comprising:
at least one battery, as a power supply;
a latching solenoid valve in at least one faucet supply line; and
a foot pedal, which, upon alternate activations, reverses the polarity of an electrical output pulse to the solenoid valve, whereby flow through the faucet is controlled in an on/off fashion by pedal activation.

2. The faucet control system of claim 1 wherein the battery and latching solenoid valve are under a sink basin.

3. The faucet control system of claim 1 wherein the at least one latching solenoid valve includes a cold-water solenoid valve and a hot-water solenoid valve, such valves being electrically connected for contemporaneous operation by the foot pedal.

4. The faucet control system of claim 3 wherein the battery and latching solenoid valve are under a sink basin.

5. The faucet control system of claim 3 wherein there is a hot-water shut-off valve and a cold-water shut off valve and wherein the hot-water latching solenoid valve and cold-water latching solenoid valve are downstream of the hot-water shut-off valve and a cold-water shut off valve respectively.

6. The faucet control system of claim 5 wherein the battery and latching solenoid valve are under a sink basin.

7. The faucet control system of claim 6 wherein the hot-water latching solenoid valve and cold-water latching solenoid valve are physically separate modules separately installed in a hot water supply line and a cold water supply line.
